(19) United States
(12) Patent Application Publication
(10) Pub. No.: US 2012/0084108 A1
(43) Pub. Date: Apr. 5, 2012

(54) SYSTEMS AND METHODS FOR A WORK FLOW MANAGEMENT APPLICATION SUITE FOR MOBILE COMMUNICATIONS DEVICES

(75) Inventors: Charles Matthew Bohannon, Acworth, GA (US); Albert Dwight Spell, JR., Ball Ground, GA (US); Karl David Goodhew, Atlanta, GA (US); Ralph Stephen Johnson, Douglasville, GA (US); Jeffrey Scott Colson, Atlanta, GA (US); Warren Charles Born, Manchester, MD (US); Chris Jurasek, Gurnee, IL (US)

(73) Assignee: ADC TELECOMMUNICATIONS, INC., Eden Prairie, MN (US)

(21) Appl. No.: 13/248,413

(22) Filed: Sep. 29, 2011

Related U.S. Application Data
(60) Provisional application No. 61/388,135, filed on Sep. 30, 2010.

(51) Int. Cl. G06Q 10/06; G06Q 50/08

(52) U.S. Cl. 705/7.12

(57) ABSTRACT

Systems and methods for a work flow management application suite for mobile communications devices are provided. In one embodiment, a method for providing work flow management from a mobile communication unit comprises: initiating a login from the mobile communication unit to a back-end database by transmitting a unique device ID for the mobile communication unit, a username and password to a supervisory server; when the logon is granted, retrieving project information records from the back-end database for one or more projects assigned to the username; and displaying on the mobile communication unit a schedule of project information for the one or more projects based on the project information records, wherein the project information includes a Method of Procedure (MOP) status for each of the one or more projects, the MOP status indicating whether a MOP to perform a work task is currently valid.

### CROSS-REFERENCE TO RELATED APPLICATIONS

This application claims the benefit of U.S. Provisional Patent Application Ser. No. 61/388,135, filed Sep. 30, 2010, titled “SYSTEMS AND METHODS FOR A WORK FLOW MANAGEMENT APPLICATION SUITE FOR MOBILE COMMUNICATIONS DEVICES”, which is hereby incorporated herein by reference.

### BACKGROUND

In the telecommunications industry, technicians are often called upon to perform work at service provider's facilities where communications equipment is in-service and must remain operational. In such facilities, the technician's work activities need to be controlled to ensure that their actions do not cause a loss of service from working on the wrong equipment, performing key activities out of sequence, or from performing work at a time not coordinated with the service provider.

For the reasons stated above and for other reasons stated below which will become apparent to those skilled in the art upon reading and understanding the specification, there is a need in the art for improved systems and methods for Work Flow Management.

### SUMMARY

Systems and methods for a work flow management application suite for mobile communications devices are provided. In one embodiment, a method for providing work flow management from a mobile communication unit comprises: initiating a login from the mobile communication unit to a back-end database by transmitting a unique device ID for the mobile communication unit, a username and password to a supervisory server; when the logon is granted, retrieving project information records from the back-end database for one or more projects assigned to the username; and displaying on the mobile communication unit a schedule of project information for the one or more projects based on the project information records, wherein the project information includes a Method of Procedure (MOP) status for each of the one or more projects, the MOP status indicating whether a MOP to perform a work task is currently valid.

### DRAWINGS

Embodiments of the present invention can be more easily understood and further advantages and uses thereof more readily apparent, when considered in view of the description of the preferred embodiments and the following figures in which:

FIG. 1 illustrates a system for managing the work flow of field work of one embodiment of the present invention;

FIG. 2 illustrates a mobile communication unit of one embodiment of the present invention for use with the system of FIG. 1;

FIG. 3-18 illustrate screen shots from a mobile communication unit having a work flow application suite of one embodiment of the present invention;

FIG. 19 is a flow chart illustrating a method of one embodiment of the present invention;

FIG. 20 is a flow chart illustrating a method of one embodiment of the present invention;

FIG. 21 is a flow chart illustrating a method of one embodiment of the present invention;

FIG. 22 is a flow chart illustrating a method of one embodiment of the present invention; and

FIG. 23 is a flow chart illustrating a method of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present invention provide field technicians and installers with a suite of applications tied to a back-end database geared at managing the quality and productivity associated with field work at in-service telecommunications/data network facilities.

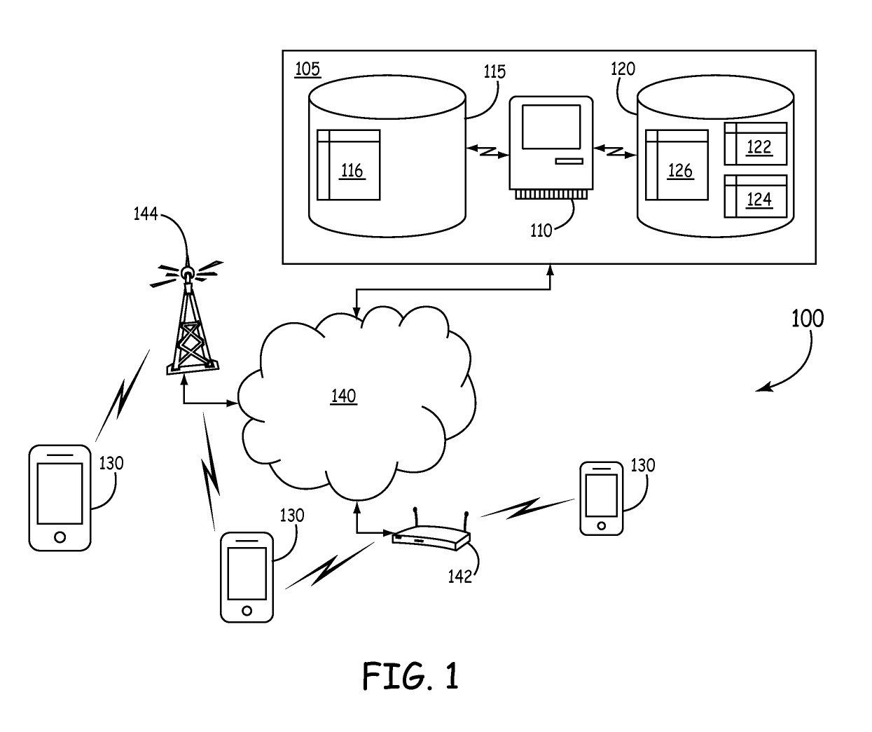

FIG. 1 illustrates a system 100 for managing the work flow of field work. System 100 comprises a supervisory server 110 with access to a project back-end database 120 and at least one corporate database 115 having materials management information 116 stored thereon (any of which can be located across one or more corporate facilities 105). System 100 further comprises a plurality of mobile units 130 each with access to the back-end database 120, and in some embodiments corporate database 115, via a network 140. In one embodiment, the function of the supervisory server 110 is distributed over a plurality of computers that are connected via a network.

In one embodiment, at least part of network 140 comprises an IP network such as the Internet and one or more mobile units 130 wirelessly connect to network 140 via a wireless network access point 142 (such as an 802.11a/b/g/n Wi-Fi access point, for example). In another embodiment, at least part of network 140 comprises a wireless telecommunications network such as, but not limited to a cellular telephone network, and mobile units 130 wirelessly connect to network 140 via the wireless telecommunications network's an antenna system 144.

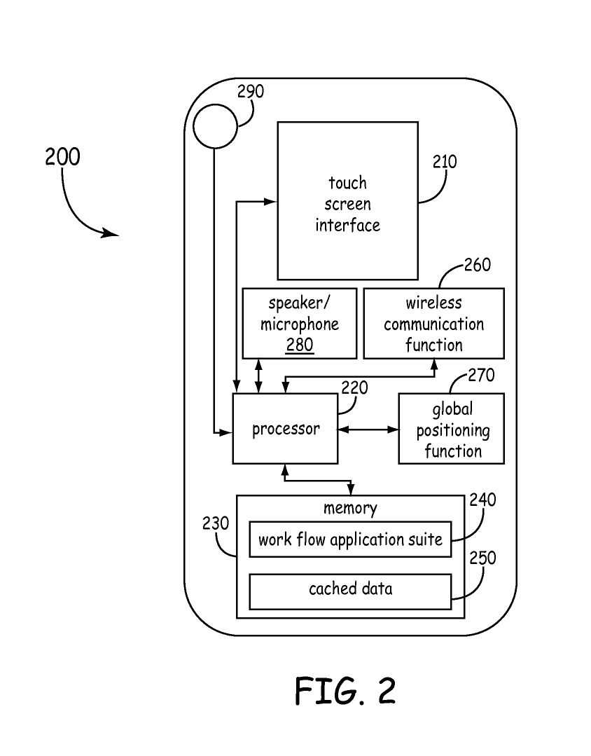

FIG. 2 illustrates a mobile unit 200 for use with the system 100 of FIG. 1. Mobile unit 200 comprises a touch screen interface 210, a processor 220, memory 230 storing a work flow application suite 240 for accessing project information stored on back-end database 120 and cached data 250 for work flow application suite 240, a wireless a wireless communication function 260, a global positioning function 270 (such as a global positioning system (GPS) receiver, for example), and at least one speaker and microphone (represented by 280) and a camera 290. Wireless communication function 260 includes transmitter and receiver circuitry which provides communications connectivity for mobile unit 200 via both wireless telecommunications networks (such as, but not limited to a cellular telephone network) and wireless network access points. In one embodiment, mobile unit 200 is a smart phone. In one embodiment, mobile unit 200 comprises an Apple iPhone cellular smart phone. In other embodiment, mobile unit 200 comprises a Blackberry or Android based smart phone.

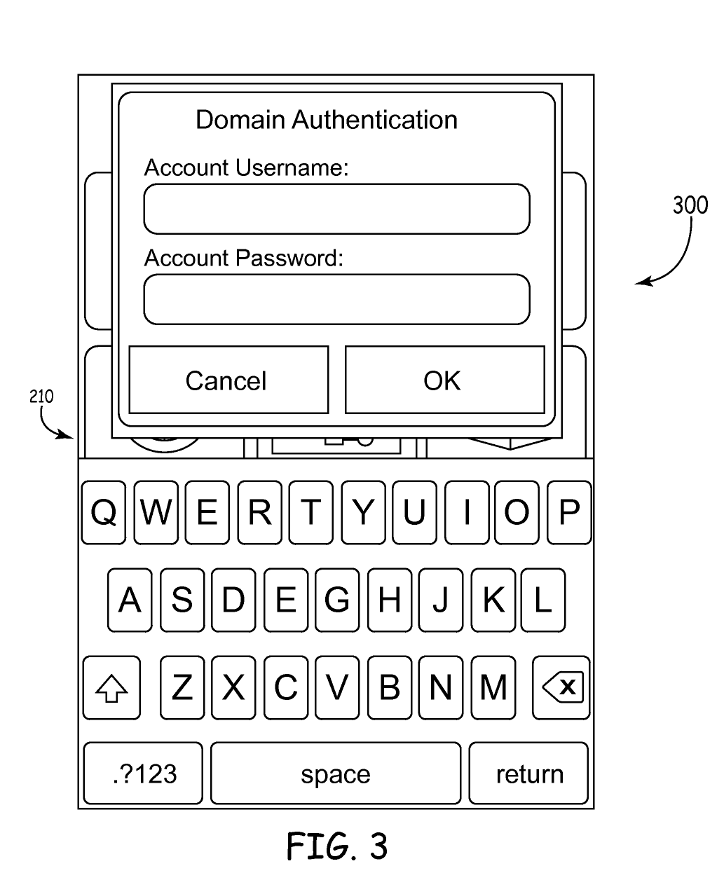

Embodiments of the present invention employ both device level authorization and domain level authorization. Device level authorization takes advantage of the fact that each mobile unit 130, 200 has its own unique device ID. Back-end database 120 includes a device registry 122 of unique device IDs for every mobile unit 130, 200 authorized to access the database 120. For example, upon execution of the work flow application suite 240, the device ID for mobile unit 200 is communicated to the back-end database 120 for verification against the device registry 122. If the device ID provided by the mobile unit 200 is not in the device registry 122, the back-end database 120 will not authorize access from mobile unit 200. Domain level authorization utilizes Active Directory. Assuming that the mobile unit 200 is listed in the device registry 122, the work flow application suite 240 will prompt the Installer for a username and password as shown in FIG. 3 generally at 300. In one embodiment, the username and password is provided back to the supervisory server 110 where Active Directory is utilized to authenticate the user as authorized to access the back-end database 120. Once authenticated, work flow application suite 240 is provided with access to project information records 126 in the back-end database 120 for any project assigned to the signed-in user. As used throughout this description, the terms “user,” “logged-in user”, “technician” and “Installer” are synonymous and refer to a validly authorized signed-in user of work flow application suite 240. Synchronization of the cache data 250 on the Installer's mobile unit 200 with the project information records 126 stored at the back-end database 120 will be described in greater detail later in this description.

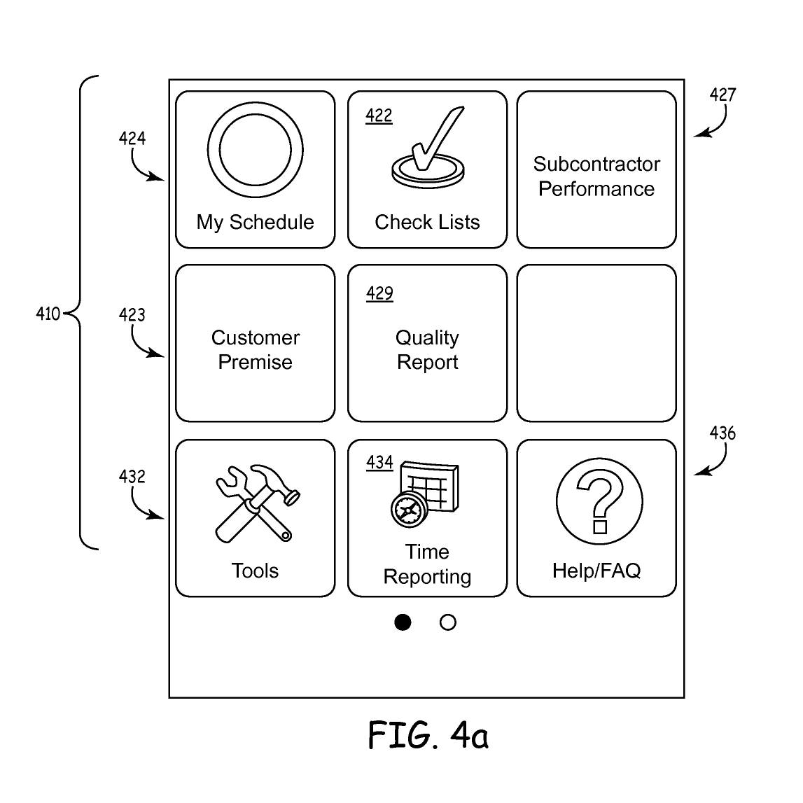

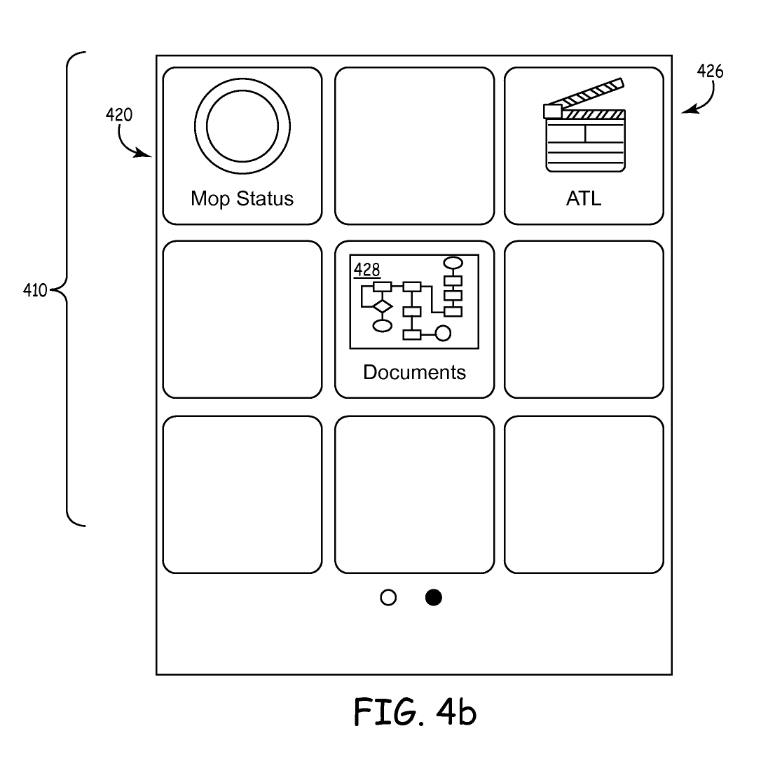

FIGS. 4a and 4b are screen shots from mobile unit 200 illustrating a plurality of applications (shown generally at 410) that make up work flow application suite 240. In particular, the work flow application suite 240 illustrated in FIGS. 4a and 4b includes one or more of a MOP Status application 420, a Checklist Application 422, Customer Premise application 423, a Scheduling Application (“My Schedule”) 424, a video library application 426 a subcontractor performance application 427, a document library application 428, a Quality Report application 429, a tools application 432, a time reporting (or “timesheet”) application 434 and a help/frequently asked question (FAQ) application 436.

As the term is used herein, a “Method of Procedure” or MOP is a procedural work control document (either physical or virtual) associated with a specific project that controls how and when work for that project will be performed. Individual projects will each have their own MOPs that field installers must adhere to when performing tasks for those projects. The MOP status application 420 is used by the Installer to view MOP information and verify when they have a valid right to enter a job site to perform work at a particular time. The job site may be located at a service provider's Central Office, Data Center or a third party facility where equipment for several service providers are co-located. The MOP status application 420 retrieves current MOP information from the project information records 126 stored at the back-end database 120, and provides the information needed for the Installer to verify that they are at the correct facility at the correct time to perform a work task.

MOP Status allows a user to view at a glance the status of many projects and procedurally prevents work on invalid projects. Check in and out is accessible from this module and automatically adds time to a users timecard. In one embodiment, the ability to check into multiple projects distributes time over the number of projects being worked on simultaneously. Additional functions of MOP status application 420 include: a default view that shows projects assigned to the logged-in user within user-defined dates, the ability to restrict projects by user-defined distance of the user from a project (i.e., only display projects within a defined distance from the users location), the ability to search the back-end database unrestrictedly for any project, and a display that informs the user at a glance whether the project is valid project to work on, invalid or otherwise undetermined. Additional details and functions are provided in alternate embodiments such as, a button to call a supervisor with one click, and maps and directions to a project.

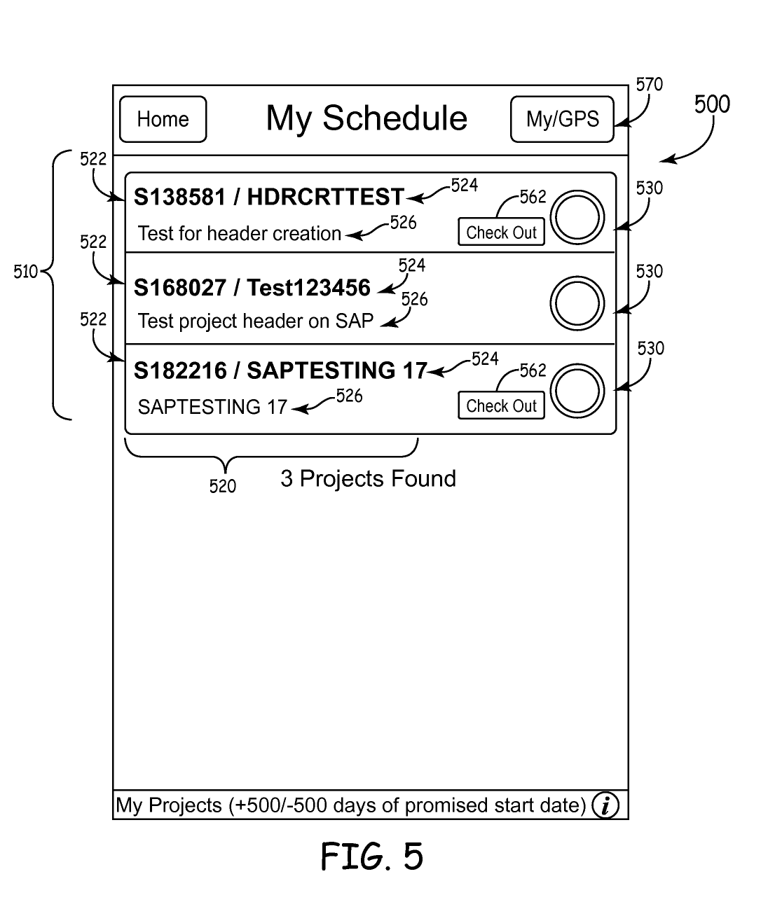

As illustrated by screenshot 500 in FIG. 5, the Scheduling application 424 provides a listing that displays the Installer's assigned jobs 510 as well as a summary of Project Information 520 and an indication of MOP status 530 for each of the jobs. Project Information 520 includes information such as, but not limited to a Project/System number 522, a brief project task identifier 524, and/or a detailed task description 526.

MOP status 530 indicates information such as whether the MOP for a performing particular job 510 is currently valid by comparing the present date and time with MOP start and expiration information provided by back-end database 120. When the present date and time falls between the MOP start and MOP expiration, the MOP status 530 indicates that a valid MOP for perform the task is available. The Installer then knows that they may proceed with the job task. In one embodiment, the MOP status 530 provides a symbolic status indication such as by displaying a green status icon when the Installer may enter the work site and work under the MOP, and a red icon when the Installer is not authorized to enter the work site or work under the MOP. In other embodiment, words, letters or other status indicators may be used instead of, or in combination with symbol for MOP status 530.

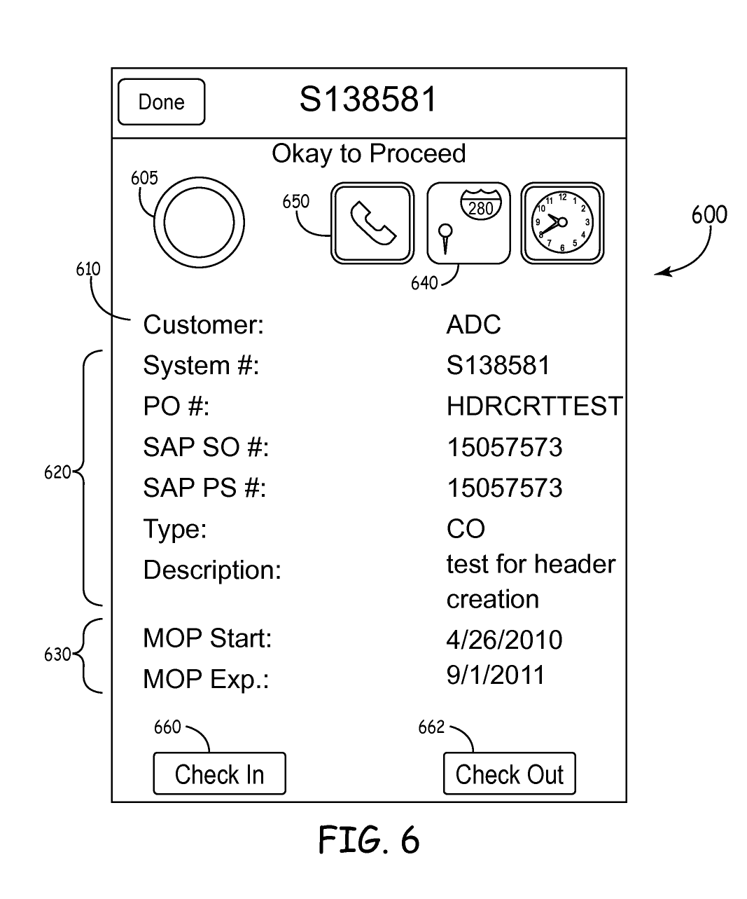

In one embodiment, the Installer select a project from the My Schedule screen 500 to obtain a more detailed project information screen 600 as shown in FIG. 6. For example, project information screen 600 may include customer information 610, more detailed project information 620 and valid MOP start and expiration information 630. In one embodiment, the project information screen 600 links the Installer to a mapping application 640 that graphically displays a location on a map where the project task is to be performed, and optionally provides directions to the job site. The project information screen 600 may optionally also include a project contact link 650 for contacting one or more supervisors responsible for that project. In one embodiment, the project contact link 650 provides a direct-dial link that initiates a phone call to the responsible supervisor.

From detailed project information screen 600 the Installer will check-in to a project when they arrive at a facility by selecting a check-in button 660. In one embodiment, the check-in button 660 is active only when a valid MOP is available for that project. Once checked-in, a check-out button 662 becomes active that permits the Installer to check out of a project when they leave the job site. In one embodiment, a check-out button 562 also becomes active on the My Schedule screen 500 for currently checked-in projects.

In one embodiment, coordinates of mobile unit 200 (such as provided by the global positioning function 270) are logged when an Installer checks in for a project. A job site registry 124 with coordinates of sites with active MOPs is maintained at back-end database 120. In one embodiment, the location of the installer at the time of check in is cross-referenced with the job site registry 124. Optionally, the Installer is notified when his position does not correlate with the location of the project they have check-in to. In one embodiment, the Schedule application 424 provides a map function (shown at 570) that, when selected, displays on touch screen interface 210 the location of all projects assigned to the Installer.

In one embodiment, from the supervisory server 110, Installer location information gathered at various installers check in can be queried from the back-end database 120 to know where Installers are currently located. Such information would be useful when supervision determines it is necessary to re-assign projects when unexpected events or scheduling conflicts arise. For example, in one embodiment, the supervisory server 110 can determine distances of several Installers from a new job site so that supervision can determine which Installer to send to the site. In one embodiment, one or both of the supervisory server 110 and the mobile unit 200 provide an alarm indication when the installer travels more than a certain distance from a checked-in location without checking out. As would be appreciated by one of ordinary skill in the art upon reading this specification, supervisory access to back-end database 120 from more than one other terminal in addition to supervisory server 110 is possible and contemplated as within the scope of embodiments of the present invention. In at least one embodiment, access to back-end database 120 is achieved from a supervisory terminal via network 140.

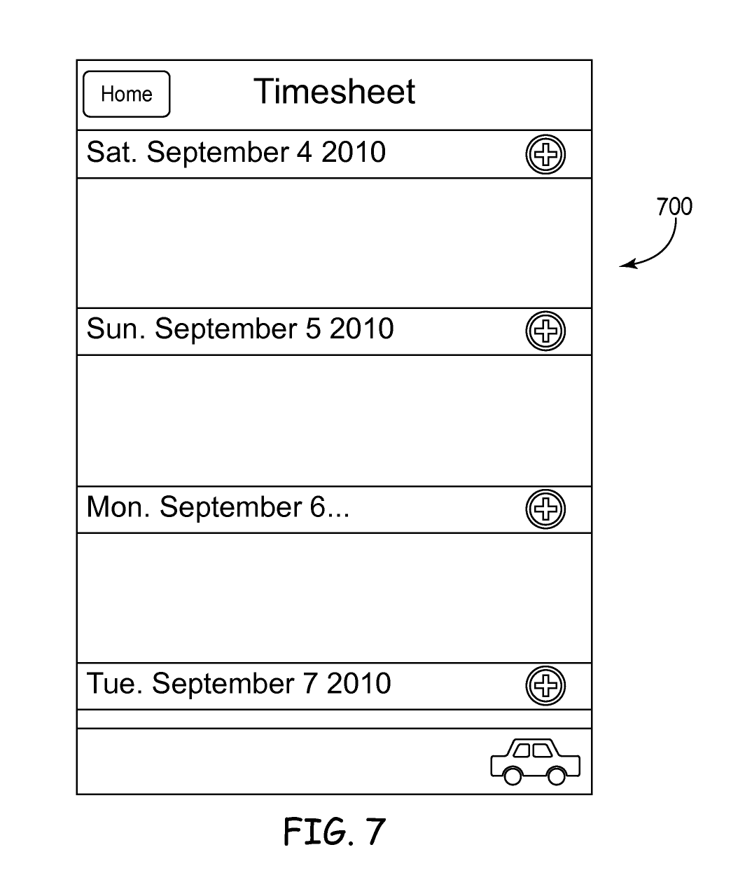

FIG. 7 provides a screen shot 700 for time reporting application 434. As the Installer checks in and checks out of projects, that information is captured by time reporting application 434 to build a timesheet for the Installer. The time reporting application 434 further allows the user to view, edit and add time entry records. In one embodiment, time reporting application 434 further permits the Installer to keep track of non-project time such a travel, training, or holidays, and keep track of millage driven and/or per Diem expenses. In one embodiment, automatic mileage calculations are performed for determining mileage reimbursements using an internet based map routing function such as, but not limited to the routing function provided by Google Maps.

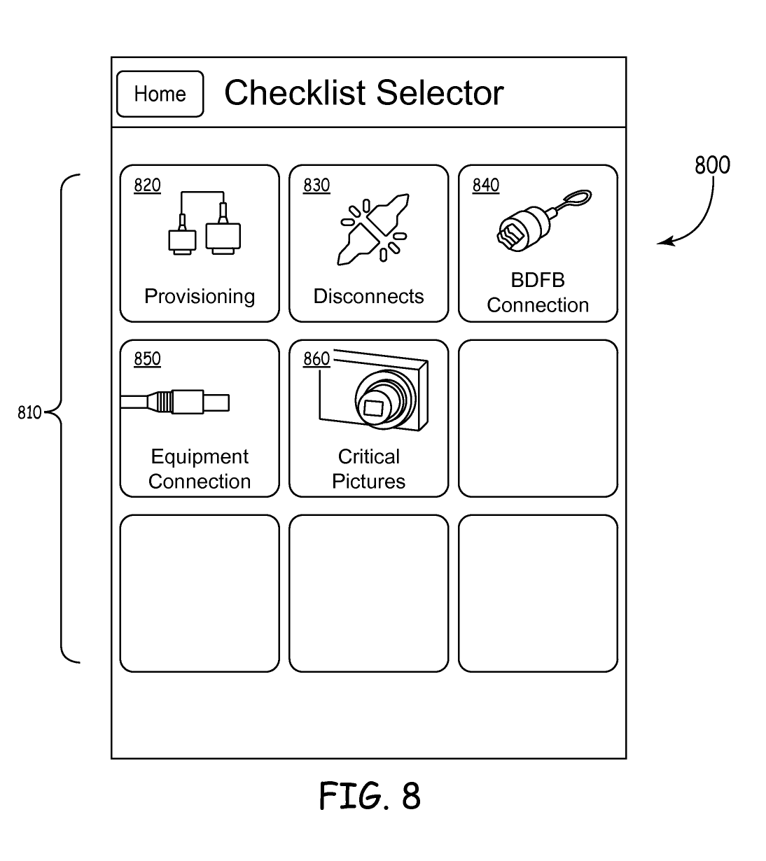

The Checklist Application 422 provides appropriate standardized work process checklists for performing work around high impact areas where mistakes in identifying equipment or performing work steps out of sequence can lead to service outages. Checklists are tailored for specific tasks on specific equipment. For example, the checklist selector screen 800 illustrated in FIG. 8 displays icons 810 for several checklist types associated with the MOP's the Installer is authorized to work under. Check Lists allow documenting the performance of certain procedures with the option of recording images at certain steps. Such checklists available under Checklist Application 422 can include, but are not limited to Application Checklist (list of checklists including which technical specific technologies to use, provisioning, equipment disconnects, BDFB Connections, Equipment Connections, capturing of critical pictures for verifying correct performance of a step, and safety related procedures. Checklists can also include procedures for starting, stopping or performing certain work tasks that are specifically relevant to certain customer premises, which in one embodiment are alternately available via the Customer Premise application 423.

In one embodiment, the checklist selector screen 800 displays only checklist icons 810 for checklists necessary for the particular MOPs they are checked into. For example, in one such embodiment, if an Installer has checked into a single MOP that requires equipment connection and provisioning, but no disconnects or BDFB connections, then when the Installer opens to the checklist selector 800, only the equipment connection 850 and provisioning 820 checklists are displayed. In an alternate implementation, icons for Disconnect checklists 820 and BDFB Connection checklists 830 are still displayed, but when the installer selects either of these two options, no checklists are displayed since no disconnects or BDFB connections are associated with the checked in MOP.

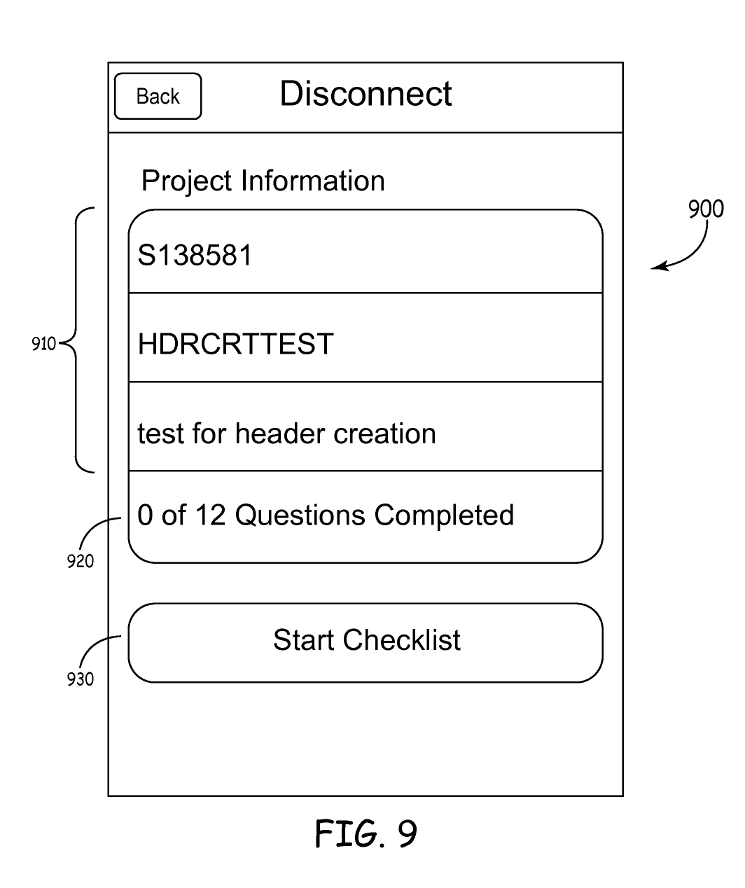

Once an installer makes a selection from the checklist selector screen 800 (for example, by selecting “Disconnects”) the checklist application 422 will display a list of any checklists of that type for any project that the Installer has checked into. When the installer then selects a particular checklist to perform, the checklist application 422 displays a sequence of items which the Installer is expected to perform and/or verify in order to successfully accomplish a particular task for that project. For example, FIG. 9 illustrates first page 900 of a disconnect checklist selected by the Installer for an example project “S13851”. In addition to displaying basic project information 910, the first page 900 indicates the number of items (questions) in the present checklist and how many have already been completed (shown at 920). An Installer would start from the beginning of new checklist, or resume from where they had previously left off for an in-progress check list, by selecting the “Start Checklist” option at 930.

Until the installer affirms completion of an item on the checklist, he cannot proceed to the next item or complete the checklist. Most checklists items are in the form of a “Yes or No” questions such as “Have you verified no service on equipment switch no. 3729?” When the Installer answers “Yes” on the checklist, then the mobile unit 200 will proceed by displaying the next checklist item. If the Installer answers “No” on the check list, then work on the checklist is suspended. In one embodiment, they are presented with contact information (or a direct dial link) for a supervisor responsible for that project. In one embodiment, a “No” response is communicated immediately to the back-end database 120 and supervisory server 110 where a supervisor is alerted. In one embodiment, the supervisor can directly contact the Installer via a voice over through mobile unit 200.

One or more items in the checklist (such as those deemed critical, for example) can require photographic verification. In those cases, the checklist application utilizes the mobile device's camera 290 to capture an image that documents completion of critical tasks. For example, the installer can capture a photograph documenting a switch position, a wire harness installation, or other equipment status. Once the checklist is completed, the checklist application logs completion at the back-end database and uploads any documentary photographs. This permits supervision to later audit the Installers performance of the job task. The Installer may review any photos they have taken for a project by selecting Critical Pictures 860 from the checklist selector screen 800.

All project information defined by the MOP, including valid MOP start and expiration times are managed from the back-end database 120. In one embodiment, when revised project and MOP information is entered at the back-end database 120, the updated information is provided to the Installer's mobile unit 200. In one embodiment, a back-end database 120 call is performed by mobile unit 200 to pull updates each time the Installer executes a command that requires the display of project information. Alternately, certain back-end database 120 updates can be pushed to the mobile unit 200. In one embodiment, data collected at the mobile unit 200 for submission to the back-end database (such as check in-check out events, completed checklist submissions, and the like) is transmitted without pulling updated project information back to the mobile unit 200.

Uniting the multiple applications 420-436 as a suite helps mitigate instances of weak connectivity with the back-end database 120. That is, the suite arrangement permits the mobile unit 200 to pull back and cache project information 126 for all the various applications in the suite 240 at once, rather than on an application-by-application basis. For example, when then Installer select the Schedule application 424, the mobile unit 200 will pull back updates associated with all projects associated with that Installer, for each of the applications 420-436 in the suite. Thus, if they arrive at a job site and experience limited connectivity, they can still proceed because updated checklist and other project and task specific information would have been automatically updated to memory 230 when the Schedule application 424 was executed. In one embodiment, the work flow application suite 240 displays an indication of the last update of project information 126 received from the back-end database 120, or if the currently cached data 250 is considered fresh or stale based on the accrued time since the last update.

With respect to sending project information captured on mobile unit 200 back to the back-end database 120 (such as check-in and check-out, completed checklist submissions, and the like) this data is communicated in real time assuming connectivity is available. For instances of weak connectivity with the back-end database 120, collected data is cached in memory 230 unit an acceptable mobile carrier or WiFi connection occurs.

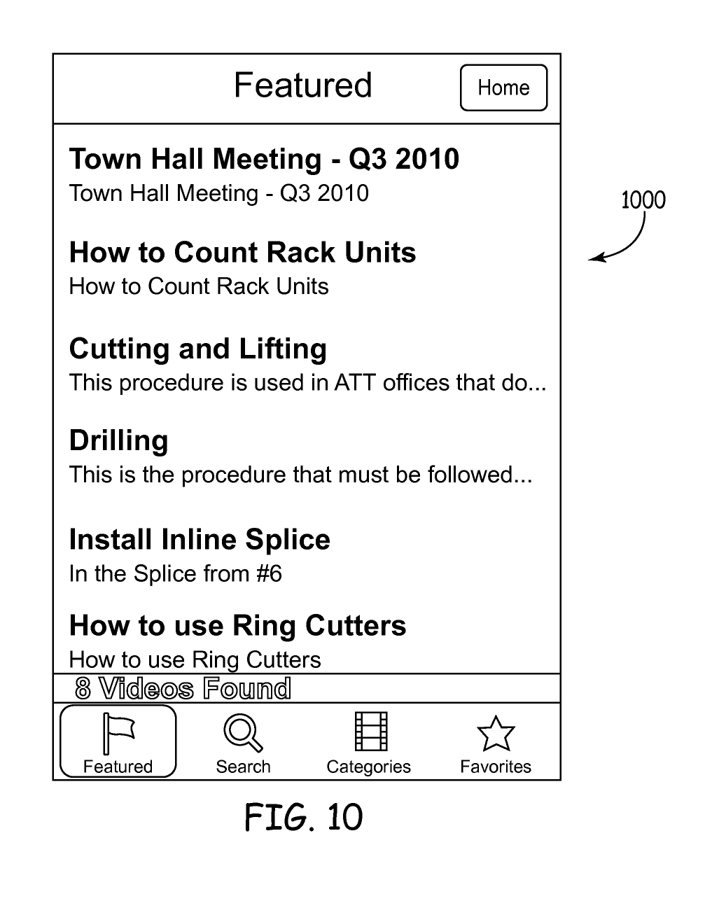

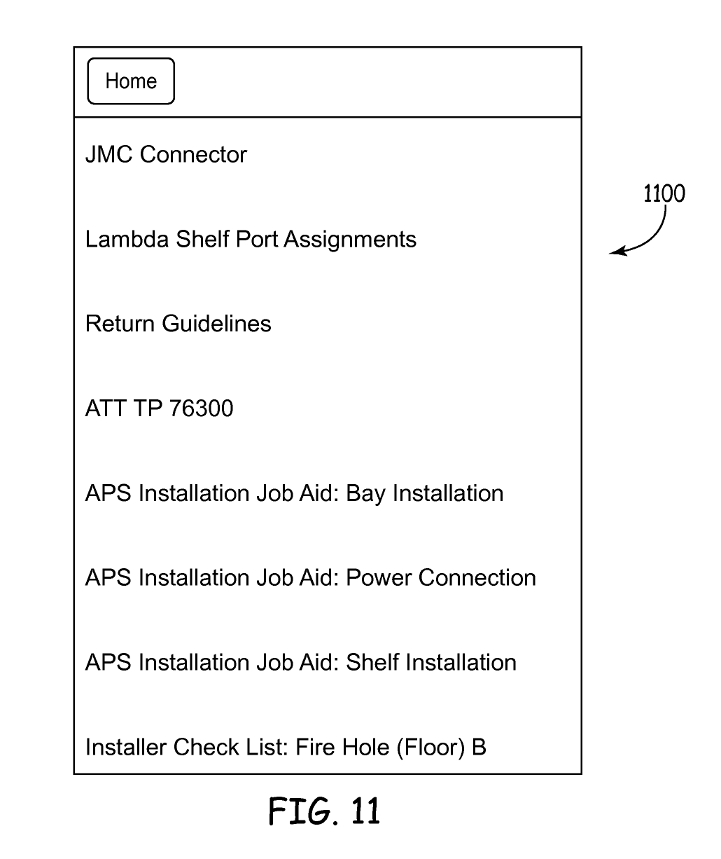

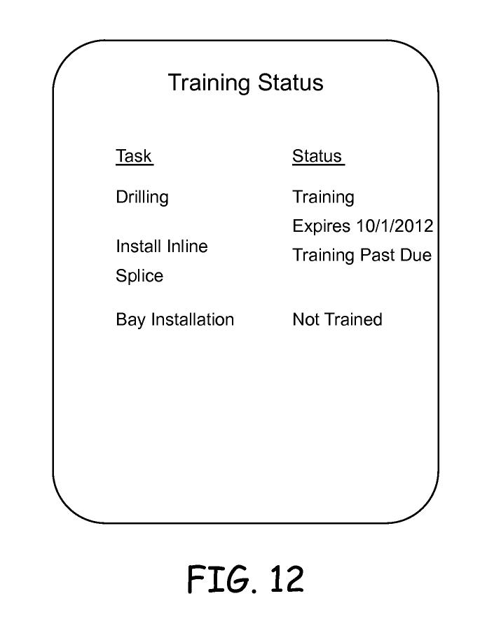

As mentioned above, in one embodiment, work flow application suite 240 further includes a training library 426 containing training videos and a documents library 428. Illustrated in FIG. 10 generally at 1000, training library 426 provides a menu of training videos that the Installer can select to obtain “how-to” information. A training video could provide guidance on how to perform specific checklist items, or may be general instruction such as how to splice a wire or drill a hole. Illustrated in FIG. 11 generally at 1100, the documents library 428 provides a menu of instruction manuals, user manuals, and installation manuals. Additional features of training library 426 include a listing of featured videos, a training library search function, the ability to browse training materials by category, the ability for the user to flag often used materials (i.e., favorites), the ability to rate or otherwise provide comments on training materials available in the library. Documents available include material such as product manuals, specification sheets, training slides, guidelines and procedures. In one embodiment, the workflow application suite 240 further accesses the back end database 120 to retrieve training records for the logged in user. From these records training status indications are displayed to the user, such as shown in FIG. 12. For example, in one embodiment, the records training status indications will indicate whether the users has received the necessary training to perform one or more tasks associated with a project assigned to them, whether their training is up-to-date or expired, or whether they require additional training before performing certain tasks.

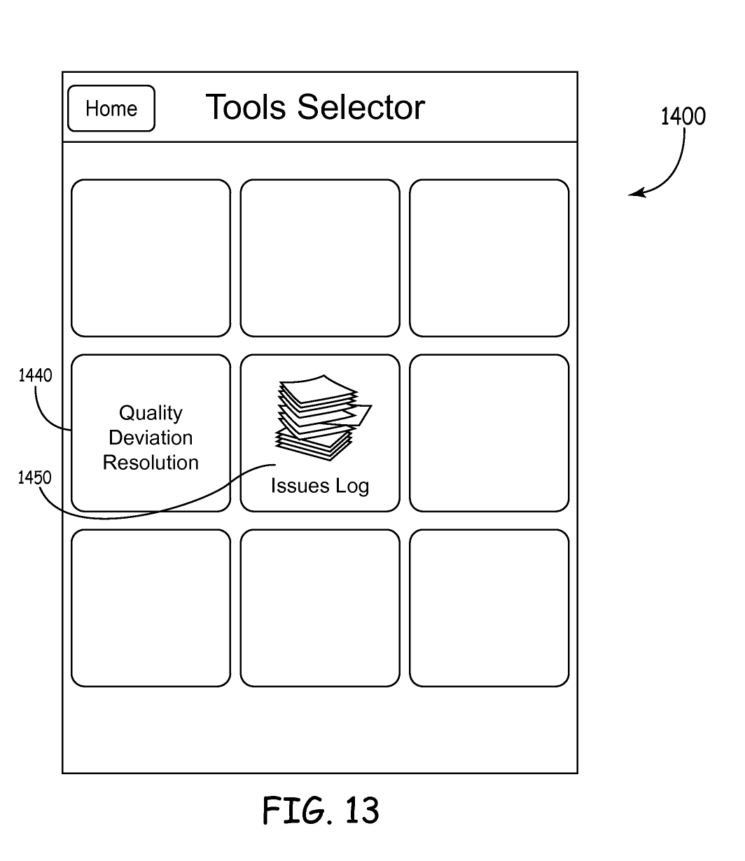

Tools Application 432 brings up a tools selector screen 1400 as shown in FIG. 13. In the embodiment shown in FIG. 13, the tools selector screen 1400 includes a “Quality Deviation Resolution” tool 1440 and an “issues log” tool 1450. In other embodiment, other tools may be provided. The “Quality Deviation Resolution” tool 1440 provides a means to track correction of deviations (that is, non-conforming conditions and workmanship quality issues) identified by quality auditors/inspectors. In one embodiment, the work flow application suite retrieves quality deviation information from the project information records and “Quality Deviation Resolution” tool 1440 displays a list of one or more deviations, and for each of the one or more deviations displays a description of correction tasks to complete.

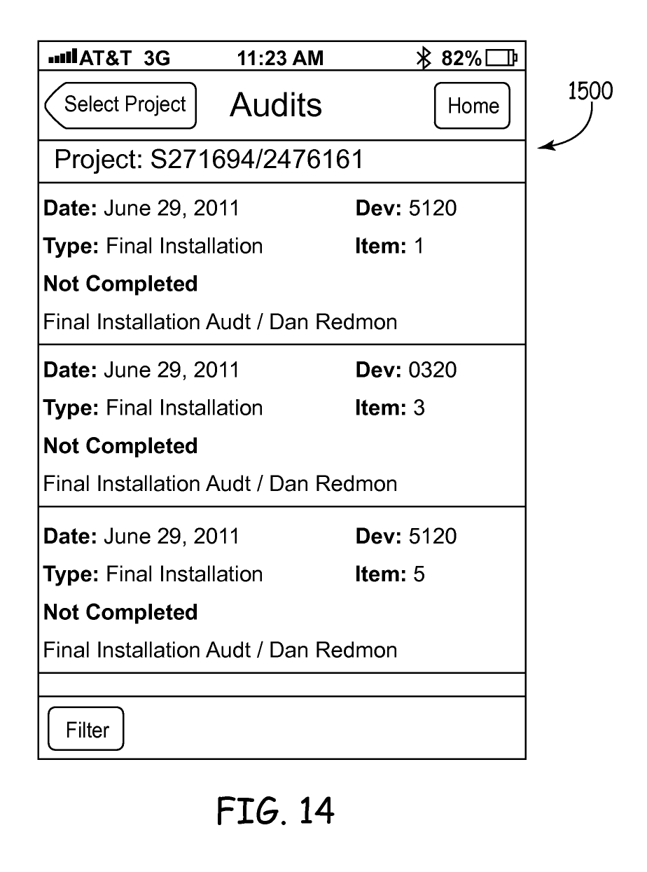

For example, when a job is completed, a quality auditor may go to the job site to perform an inspection. Any deviations in quality are noted and entered into the project information records 126. When an installer is assigned the task of resolving the deviations, the “Quality Deviation Resolution” tool 1440 provides a list of those deviations (as shown at 1500 in FIG. 14), a description of what is necessary to correct the deviation, an a means to document what was done to resolve the deviation back into the project information records 126. For example, where an auditor has identified a cable that is misrouted on a panel, the installer assigned to correct the deviation will look up the problem via the “Quality Deviation Resolution” tool 1440 and then take one or more photographs (for example, before and after). The photographs are transmitted back to the project information records 126 to documents where he correctly re-routed the cable.

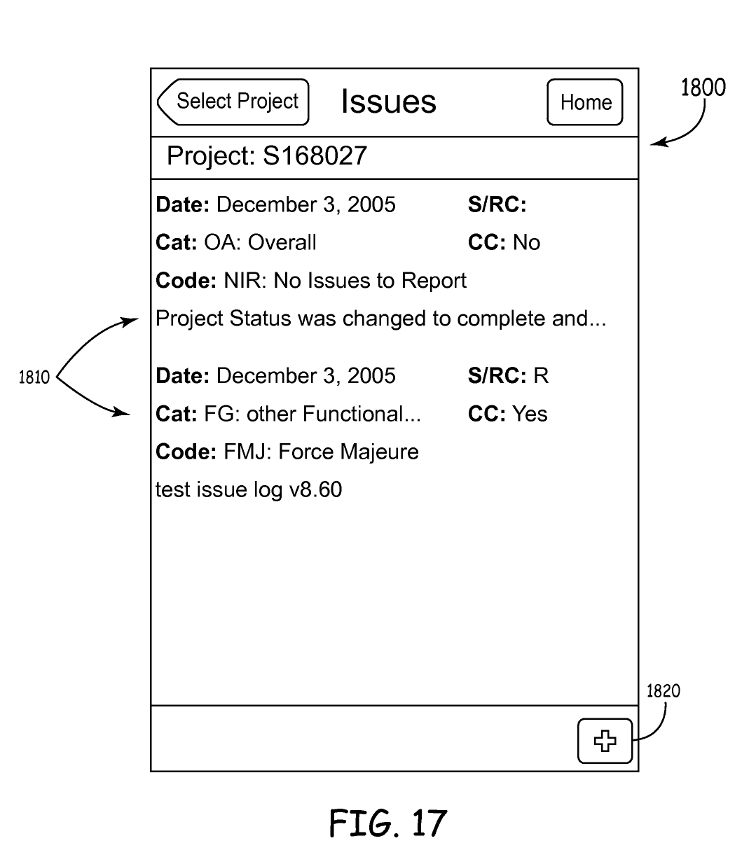

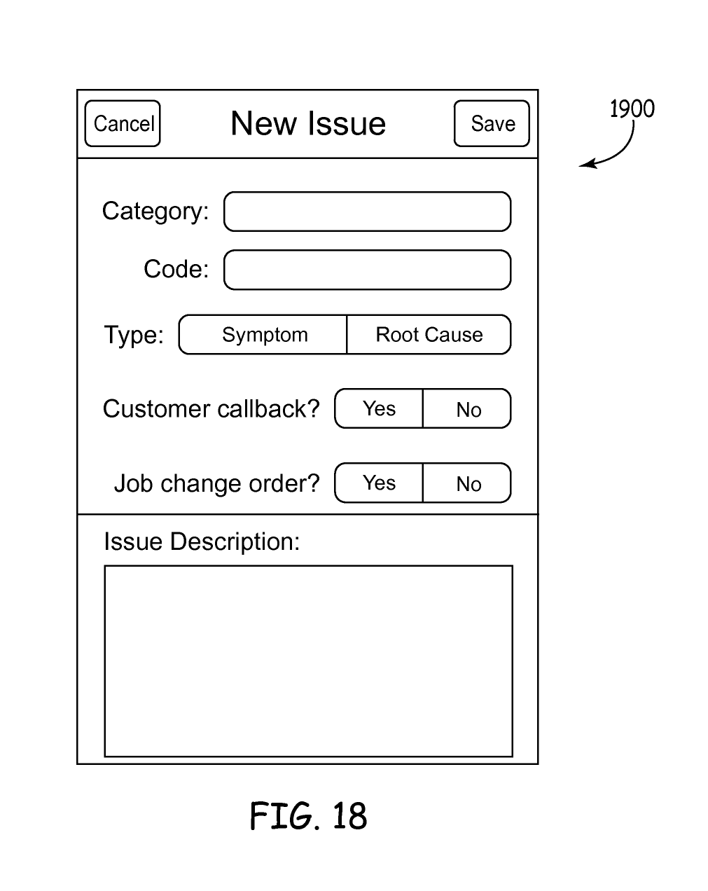

The “issues log” tool 1450 provides installers with a means to document and communicate issues affecting progress at a work site. For example, when an Installer arriving or working at a work site discovers they cannot proceed with their task as planned, they can document the situation as an “issue”. Examples of an issue include missing or incorrectly delivered parts and unexpected delays or denied access to needed facilities. Another example of an issue would be where a service operator decides to change or expand the scope of work associated with a project (for example, instructing the installer to install three bays of equipment rather than one). By bringing up the issues screen 1800 in FIG. 17, an installer can review details of issues previously reported for a project, as shown generally at 1810 or enter a new issue by selecting the add issue button 1820. Upon selecting the add issue button 1820, a new issue screen 1900 is provided as shown in FIG. 18. They can then enter a predefined category and code information that describes the issue and a description, whether the issue requires a job change order, and whether a customer callback is required to resolve the issue. Upon saving the new issue, it is communicated back to the project information records 126. In one embodiment, depending on the nature of the issue (for example, based on the category and/or code selected by the installer) a project manager and/or engineer is immediately notified (via a display on supervisory server 110, another computer, or via an electronic message, for example) to contact the installer.

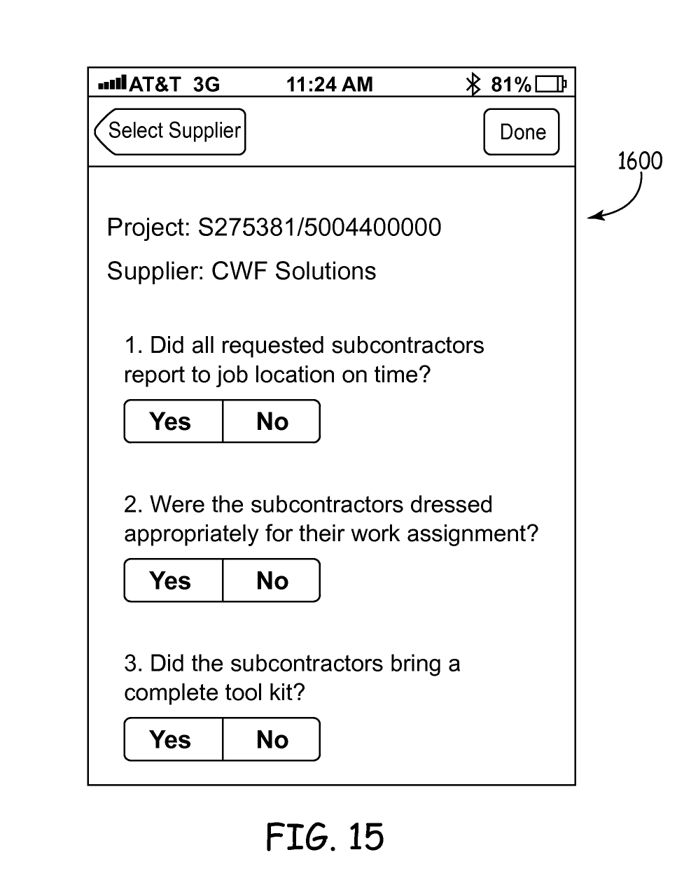

The “subcontractor performance” application 427 provides an interface for the user to report and rate various aspects of a subcontractor's performance. FIG. 15 provides an example for one implementation generally at 1600. The information collected for a project it transmitted back to the back-end database 120 where it can be compiled for reporting. In alternate embodiments, subcontractor performance tool 1480 provides fields for reporting specific performance metrics such as, but not limited to, a subcontractors on-time reporting to a job site, a measure of the subcontractors abilities and skills and assessment of the work performed after an assignment is completed.

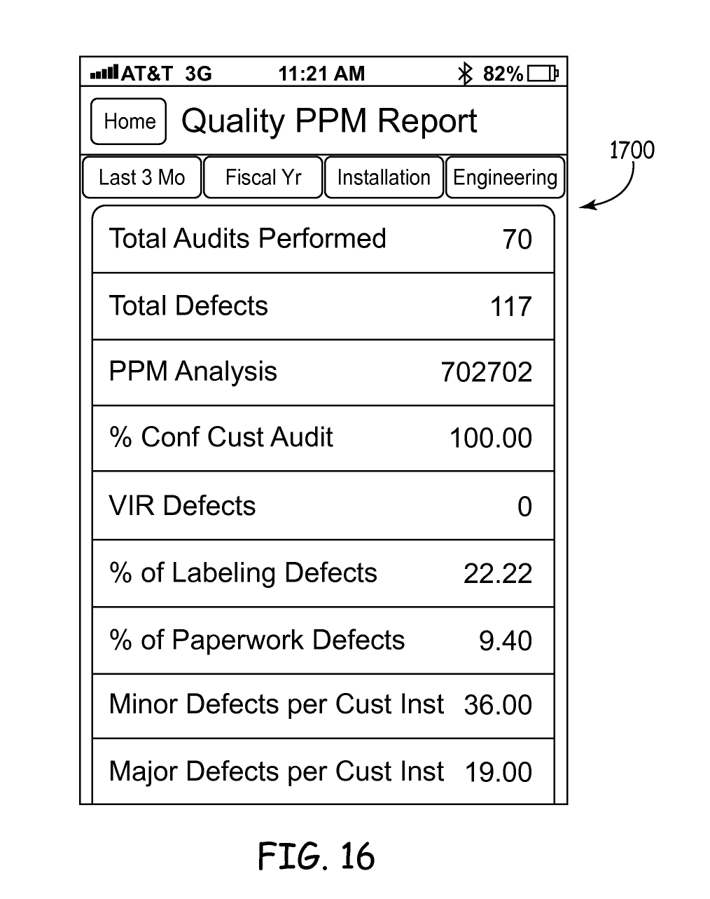

The “quality report” application 429 displays current data on organization level quality statistics for some preceding period of time (e.g., for the preceding quarter or the current fiscal year). An example of one such display is illustrated generally at 1700 in FIG. 16 of the statistics provided in a dashboard display format. Statistics displayed can include, but are not limited to, the total number of quality audits performed, the total number of defects identified, and percentages of defects identified per tasks performed for different categories of tasks.

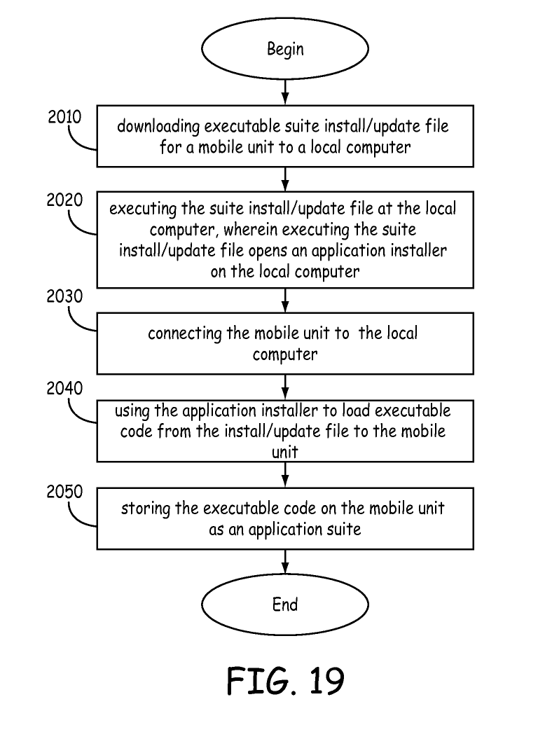

FIG. 19 is a flow chart illustrating a method for installing and updating work flow application suite (such as updating work flow application suite 240) on a mobile unit (such as mobile unit 200, for example) via a local computer. The method begins at 2010 with downloading executable suite install/update file for a mobile unit to a local computer. The method proceeds to 2020 with executing the suite install/update file at the local computer, wherein executing the suite install/update file opens an application installer on the local computer. For embodiments where the mobile unit is an Apple iPhone or Apple iPad device, the application installer could be the Apple iTunes application, for example. The method proceeds to 2030 with connecting the mobile unit to the local computer. This may be done via a universal serial bus (USB) cable, for example. The method proceeds to 2040 with using the application installer to load executable code from the install/update file to the mobile unit. The method proceeds to 2050 with storing the executable code on the mobile unit as an application suite.

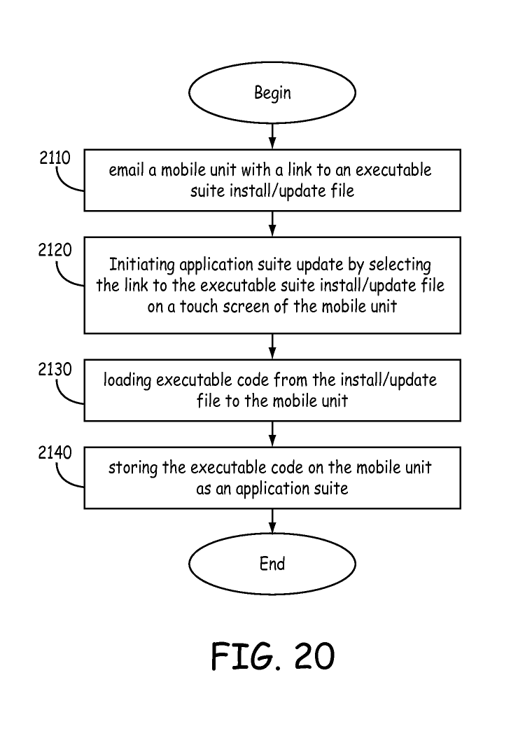

FIG. 20 is a flow chart illustrating a method for installing and updating a work flow application suite (such as updating work flow application suite 240) on a mobile unit (such as mobile unit 200, for example) via a link through an email message. The method begins at 2110 with emailing a mobile unit with a link to an executable suite install/update file. The method proceeds to 2120 with initiating a work flow application suite update by selecting the link to the executable suite install/update file on a touch screen of the mobile unit. The method proceeds to 2130 with loading executable code from the install/update file to the mobile unit. The method proceeds to 2140 with storing the executable code on the mobile unit as an application suite.

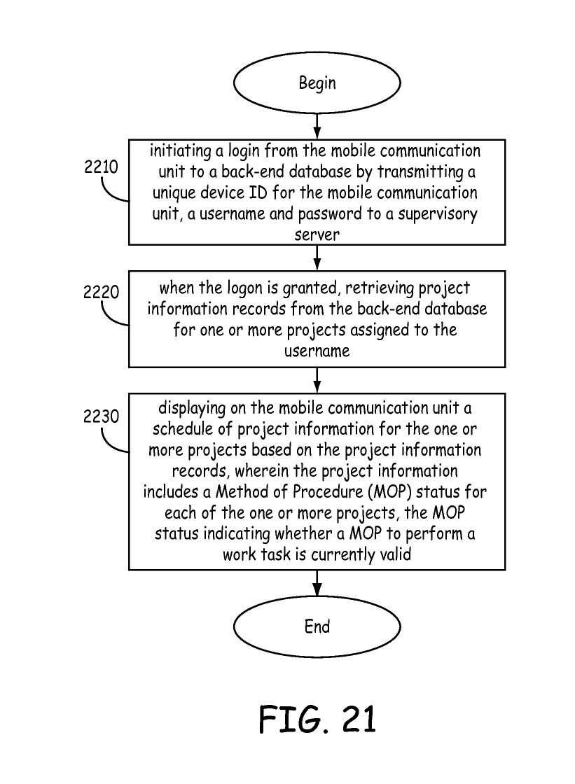

FIG. 21 is a flow char illustrating a method for providing work flow management from a mobile communication unit. In one embodiment, the method is implemented using the mobile unit 200 described in FIG. 2 for utilization with the system 100 of FIG. 1.

The method begins at 2210 with initiating a login from the mobile communication unit to a back-end database by transmitting a unique device ID for the mobile communication unit, a username and password to a supervisory server. As mentioned above, embodiments of the present invention employ both device level authorization and domain level authorization. Device level authorization takes advantage of the fact that each mobile unit has its own unique device ID. The back-end database includes a device registry of unique device IDs for every mobile communication unit authorized to access the database. If the device ID provided by the mobile communication unit is not in the device registry, the back-end database will not authorize access from mobile communication unit. In one embodiment, assuming that the mobile communication unit is listed in the device registry, the work flow application suite will prompt the Installer at the mobile device for a username and password. The username and password is provided back to the supervisory server to authenticate the user as authorized to access the back-end database. In one embodiment, this is performed at the supervisory server using Active Directory. Once authenticated, work flow application suite is provided with access to project information records in the back-end database for any project assigned to the signed-in user.

The method proceeds to 2220 with, when the logon is granted, retrieving project information records from the back-end database for one or more projects assigned to the username. These project information records are stored locally in the memory of the mobile communication device and thus may be further accessed by other functions of the work flow management suite even when a communication link between the mobile communication device and the back-end database is not immediately available. In one embodiment, retrieving project information records from the back-end database further comprises synchronizing project information records stored on the back-end database with project information records stored on the mobile device. Changes and updates to the project information are cached in the local memory until the communication link can be re-established and a synchronization performed. In one embodiment, the work flow management suite displays to the Installer information such as the time the last successful synchronization occurred.

The method proceeds to 2230 with displaying on the mobile communication unit a schedule of project information for the one or more projects based on the project information records, wherein the project information includes a Method of Procedure (MOP) status for each of the one or more projects, the MOP status indicating whether a MOP to perform a work task is currently valid. That is, the MOP status indicated to an installer whether they have a valid right to enter a job site to perform work at that particular time. The MOP status is based on the information from the project information records stored at the back-end database and provides the information needed for the Installer to verify that they are at the correct facility at the correct time to perform a work task. In one embodiment, the MOP status provides a symbolic status indication by displaying a first status icon when a logged-in user is authorized to enter a work site, and a second status icon when the logged-in user is not authorized to enter the work site.

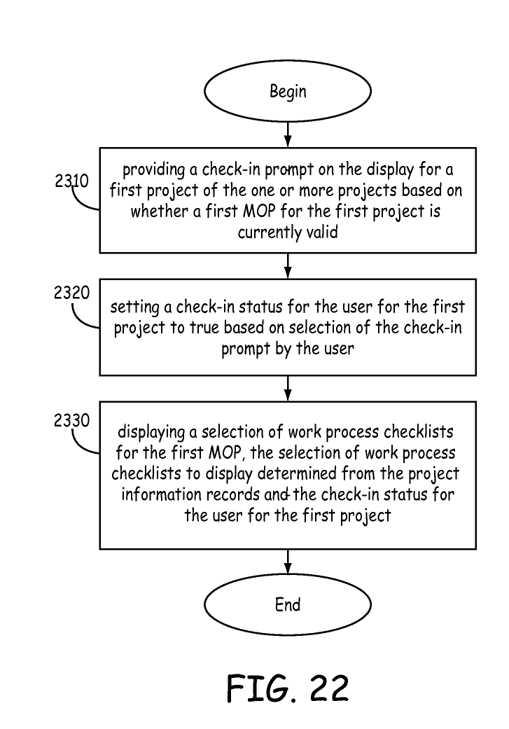

In one embodiment, shown in FIG. 22 the method continues at 2310 with providing a check-in prompt on the display for a first project of the one or more projects based on whether a first MOP for the first project is currently valid, 2320 with setting a check-in status for the user for the first project to true based on selection of the check-in prompt by the user, and 2330 with transmitting the check-in status for the first user for the first project to the back-end database. Then, based on which projects are checked-in, the method proceeds to 2340 with displaying a selection of work process checklists for the first MOP, the selection of work process checklists to display determined from the project information records and the check-in status for the user for the first project.

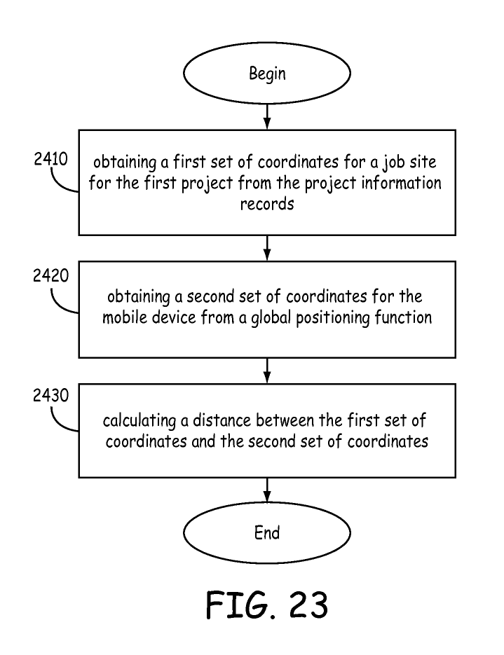

As mentioned previously, the back-end database stores project information records including a job site registry storing coordinates of job site facilities. Thus in one embodiment, shown in FIG. 23, the method continues at 2410 with obtaining a first set of coordinates for a job site for the first project from the project information records, 2420 with obtaining a second set of coordinates for the mobile device from a global positioning function; and to 2430 with calculating a distance between the first set of coordinates and the second set of coordinates. Optionally, the method may proceed to 2440 with generating a warning to the touch screen interface when the distance between the first set of coordinates and the second set of coordinates exceeds a predetermined threshold. In one embodiment, the distance is calculated along a route traveled by the installer (such as a highway) by accessing an internet based map routing function (such a Google Maps, for example) to calculate the distance between the first set of coordinates and the second set of coordinates.

Several means are available to implement the systems and methods of the current invention as discussed in this specification. In addition to any means discussed above, these means include, but are not limited to, digital computer systems, microprocessors, programmable controllers, field programmable gate arrays (FPGAs) and application-specific integrated circuits (ASICs). Therefore other embodiments of the present invention are program instructions resident on computer readable media which when implemented by such means enable the controllers to implement embodiments of the present invention. Computer readable media include devices such as any physical form of computer memory, including but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device. Program instructions include, but are not limited to computer-executable instructions executed by computer system processors and hardware description languages such as Very High Speed Integrated Circuit (VHSIC) Hardware Description Language (VHDL).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A mobile communication device for a workflow management system, the device comprising:
a processor;
a touch screen interface coupled to the processor;
a memory coupled to the processor, the memory storing a work flow application suite for accessing project information stored on a back-end database, the memory further storing cached data for the work flow application suite;
a wireless communication function coupled to the processor;
a global positioning function coupled to the processor;
at least one speaker coupled to the processor; and
a microphone coupled to the processor;
wherein the wireless communication function includes transmitter and receiver circuitry which provides communications connectivity for the mobile communication device to the back-end database via both wireless telecommunications networks and wireless network access points;
wherein the work flow application suite includes computer executable code executed by the processor which causes the processor to initiating a login to the back-end database by transmitting a unique device ID for the mobile communication device, and a username and password to a supervisory server;
wherein when the logon is granted by the supervisory server, the work flow application suite causes the processor to retrieve project information records from the back-end database for one or more projects assigned to the username;
wherein the work flow application suite causes the processor to display onto the touch screen interface a schedule of project information for the one or more projects based on the project information records, wherein the project information includes a Method of Procedure (MOP) status for each of the one or more projects, the MOP status indicating whether a MOP to perform a work task is currently valid.

2. The mobile communication device of claim 1, wherein the login is granted when the supervisory server determines that access to the back-end database is authorized for the combination of the username and the unique device ID.

3. The mobile communication device of claim 1, wherein the back-end database stores project information records including a job site registry storing coordinates of job site facilities.

4. The mobile communication device of claim 1, wherein the work flow application suite causes the processor to display onto the touch screen interface a check-in prompt for a first project of the one or more projects based on whether a first MOP for the first project is currently valid, and sets a check-in status for the user for the first project to true based on selection of the check-in prompt by the user.

5. The mobile communication device of claim 4, wherein the work flow application suite causes the processor to transmit the check-in status for the first user for the first project to the back-end database.

6. The mobile communication device of claim 4, wherein the work flow application suite causes the processor to display onto the touch screen interface a selection of work process checklists for the first MOP, the selection of work process checklists determined from the project information records and the check-in status for the user for the first project.

7. The mobile communication device of claim 1, wherein the work flow application suite instructs the processor to:
obtain a first set of coordinates for a job site for the first project from the project information records;
obtain a second set of coordinates for the mobile device from a global positioning function; and
calculate a distance between the first set of coordinates and the second set of coordinates.

8. The mobile communication device of claim 7, wherein the work flow application suite instructs the processor to:
generating a warning to the touch screen interface when the distance between the first set of coordinates and the second set of coordinates exceeds a predetermined threshold.

9. The mobile communication device of claim 7, wherein the work flow application suite access an internet based map routing function to calculate the distance between the first set of coordinates and the second set of coordinates.

10. The mobile communication device of claim 1, wherein the work flow application suite generates timesheet time entries for the first project for the user based on project check-in and project check-out inputs received via the touch screen interface.

11. The mobile communication device of claim 1, wherein the MOP status provides a symbolic status indication by displaying a first status icon when a logged-in user is authorized to enter a work site, and a second status icon when the logged-in user is not authorized to enter the work site.

12. The mobile communication device of claim 1, wherein the work flow application suite instructs the processor to synchronize project information records stored on the back-end database with project information records stored on the mobile device; and wherein a synchronization status indication is displayed to the touch screen interface.

13. A work flow management system, the system comprising:
at least one supervisory server with access to a back-end database, and
a plurality of mobile units each with a work flow application suite stored thereon, the work flow application suite having access to the back-end database via a wireless network;
the back-end database storing project information records, a mobile unit device registry including a unique device ID for each respective mobile unit of the plurality of mobile units authorized to access the back-end database, and a job site registry storing coordinates of job site facilities;
wherein upon initiating access to the back-end database, the work flow application suite transmits to the supervisory server the unique device ID for the mobile unit executing the work flow application suite and an Domain Level username and password for a user of the work flow application suite.

14. The work flow management system of claim 13, wherein the work flow application suite pulls project information records from the back-end database for one or more projects assigned to the user of the work flow application suite; and
wherein the work flow application suite displays onto a touch screen interface a schedule of project information for the one or more projects based on the project information records, wherein the project information includes a Method of Procedure (MOP) status for each of the one or more projects, the MOP status indicating whether a MOP to perform a work task is currently valid.

15. The work flow management system of claim 13, wherein the work flow application suite provides a warning when a first mobile device's location as determined by a global positioning function in the first mobile device is more than a pre-defined distance from a location of an assigned project job the user has checked-in as determines based on job site coordinates received from the job site registry.

16. The work flow management system of claim 13, wherein the work flow application suite generates time reporting information that logs when the user checks-in and checks-out of an assigned project job and generates timesheet information for the user from the time reporting information.

17. The work flow management system of claim 13, wherein the work flow application suite retrieves from the back-end database training records for the user and displays one or more training status indications based on the training records.

18. The work flow management system of claim 13, wherein the work flow application suite retrieves quality deviation information from the project information records and displays a list of one or more deviations, and for each of the one or more deviations displays a description of correction tasks to complete.

19. A method for providing work flow management from a mobile communication unit, the method comprising:
initiating a login from the mobile communication unit to a back-end database by transmitting a unique device ID for the mobile communication unit, a username and password to a supervisory server;
when the logon is granted, retrieving project information records from the back-end database for one or more projects assigned to the username;
displaying on the mobile communication unit a schedule of project information for the one or more projects based on the project information records, wherein the project information includes a Method of Procedure (MOP) status for each of the one or more projects, the MOP status indicating whether a MOP to perform a work task is currently valid.

20. The method of claim 19, the method further comprising:
displaying onto a touch screen interface of the mobile communication unit a check-in prompt for a first project of the one or more projects based on whether a first MOP for the first project is currently valid, and sets a check-in status for the user for the first project to true based on selection of the check-in prompt by the user; and
displaying onto the touch screen interface a selection of work process checklists for the first project, the selection of work process checklists determined from the project information records and the check-in status for the user for the first project.
